(19) United States
(12) Patent Application Publication
(10) Pub. No.: US 2021/0347546 A1
(43) Pub. Date: Nov. 11, 2021

(54) RECYCLABLE FLEXIBLE PACKAGING FILM

(71) Applicant: Super Sonic Sealing, LLC d/b/a SupraFlexx, Florissant, CO (US)

(72) Inventor: Tony Knoerzer, Florissant, CO (US)

(21) Appl. No.: 17/308,527

(22) Filed: May 5, 2021

Related U.S. Application Data
(60) Provisional application No. 63/020,646, filed on May 6, 2020.

(51) Int. Cl. B65D 65/40; B32B 7/12; B32B 27/32; B32B 27/08; B65D 65/42

(52) U.S. Cl. CPC B65D 65/40; B32B 7/12; B32B 27/32; B32B 27/08; B32B 2255/205; B32B 2250/242; B32B 2439/00; B32B 2255/10; B32B 2307/4023; B65D 65/42

(57) ABSTRACT

The present invention is directed towards polyethylene (PE) laminated film structures which may be easily recycled with existing recycle streams. In one aspect, the finished film structure of the present invention has one or more PE layers with each layer having only one or multiple coextrusions. In one aspect, the film structure of the present invention further comprises a homogeneous film of a single PE layer with an optional graphics layer. In one aspect, the film structure of the present invention further comprises one or more PE skin layers to promote ink adhesion for the addition of a graphics layer. In one aspect, the film structure of the present invention further comprises a sealant layer for forming a back seal on packaging comprising one or more embodiments of the inventive film structure disclosed herein with known ultrasonic sealing techniques.

### CROSS-REFERENCE TO RELATED APPLICATIONS

This application claims the benefit of U.S. Provisional Patent Application Ser. No. 63/020,646 filed May 6, 2020, and entitled “Recyclable Flexible Packaging Film”, which is incorporated herein by referenced in its entirety.

### TECHNICAL FIELD

The present invention relates to a polyethylene based, recyclable flexible packaging material and structure that can be used in flexible packaging, such as packaging for food products, and to a method of making the recyclable packaging material.

### BACKGROUND OF THE INVENTION

Multi-layered film structures made from oriented polypropylene (OPP) are often used in flexible packages because of OPP's barrier, sealant, and graphics-capability properties. Barrier properties, intrinsic or supplemental, in one or more layers are important in order to protect the product inside the package from light, oxygen and moisture. The protection of foodstuffs, which may spoil or stale, require product appropriate levels of moisture, oxygen and light transmission protection from the packaging to prevent the occurrence of stale, rancid and spoiled product. The sealant properties of the flexible packaging must provide several important characteristics. It must make a seal with appropriate hermeticity for the product being packaged. It also must function on the bagmaker, maintaining a useable seal range and sufficient hot tack to support the product being packaged while the machine is operating at speed.

Artwork (graphics) is required for product identification by the consumer and to convey other required information, such as nutritional, pricing and various bar codes. A prior art film for packaging potato chips and similar snacks is shown in FIG. 1. The film is a multilayer structure comprised of three major layers with each one consisting of multiple sub-layers. The major layers are known as films and the sub layers are commonly known as coextrusions. Each major layer plays a role (carrier of artwork, stiffness, barrier, sealability, etc.) with the coextruded sublayers providing enhanced performance of the major layer. For example, the graphics film 101 is typically reverse printed with graphics where the artwork is printed on sublayer 113 and viewed through the other transparent outer coextruded layers of 111 and 112 which together with layer 113 compose film 101. Like numerals are used throughout this description to describe similar or identical parts, unless otherwise indicated. This outer layer 101 is typically comprised of OPP or polyethylene terephthalate (PET) with OPP being preferred because of its superior economics.

Barrier layer 102 often has three coextruded layers and it is not uncommon to see up to seven layers. In this example, barrier layer 102 has a coextruded adhesion layer 121, a core 122 and a sealant layer 123. A metal layer 141 of vacuum deposited aluminum is applied to the adhesion layer 121. The aluminum provides substantial moisture, oxygen and light barrier required for certain products such as potato chips and is well known in the art. Other products, such as tortilla chips and pretzels do not require light or oxygen barrier and substantially less moisture barrier, in that case the metallized layer 141 is omitted. A sealant layer 123 coextruded with the OPP core 122 enables a hermetic end seal to be created at a temperature below the melt temperature of the OPP. This enables the seals to be made without distortion that may result if the OPP core melt temperature was reached.

Another attribute of the presence of a sealant layer is the ability to provide good hot tack during heat sealing operations. Hot tack is the ability of the seal to withstand the weight of the falling product (e.g. potato chips) while the seal is still warm. In normal operation, bagmakers drop the product onto the seal immediately following its creation. In fact, the weigher often drops the product before the seal is made and the seal is produced while the product is falling from the overhead weigher towards the seal. This is well known in the art and essential to operating bagmakers at speed. Without good hot tack the seals could require several seconds to cool, substantially slowing the bagmaker. It is not uncommon for bagmakers to package snacks at 100 bags/minute, indicating a cooling time of well less than 1 second which is insufficient unless the sealant layer is designed to withstand the impact and weight while still hot. The need for hot tack requires sealant layers that are complex mixtures of several polymers that melt at lower temperatures than the OPP core. Thus, the sealant layers are incompatible with the core layer when the film is recycled. The result is that the sealant layers cause the recycled structure to have unusable levels of gels. Gels are semisoft regions of partially melted, partially hardened layer of polymer.

In typical VFFS (vertical form fill and seal) systems, the inner sealant layer 123 is heat sealed against the outer sealant layer 111 to form the vertical back seal. These sealant layers are different because the inner layer 123 is designed for seal strength and hot tack while the outer layer 111 is designed for coefficient of friction or “COF.” A film's COF provides a relative indication of frictional characteristics and controlling COF gives processors the ability to optimize performance and avoid problems in forming, transporting, and storing of packaging films.

For example, in VFFS systems too much friction of the sealant side of the film can cause poor film feeding over metal forming collars, inconsistent package sizes, and squealing. These layers, while required, further challenge the recyclability of the OPP film because they are incompatible with the core resin. Typical prior art inner and outer sealant layers 123,111 include an ethylene-propylene co-polymer and an ethylene-propylene-butene-I terpolymers. The lamination layer 103 that adheres the outer layer 101 to the inner layer 102 is typically a polyethylene extrusion. In some cases, it is a polyethylene extrusion with a polypropylene layer in the core. These two layers are designed to be incompatible and thus provide an easy open feature. The combination of the sealant layers and lamination layer result in a structure that is ⅓ to ½ non-polypropylene and is difficult to recycle and relegated to use as a bulk filler in thick pieces such as artificial landscape timbers. Use of non-polyolefin materials such as polyester, nylon and paper render the recycling of the package virtually impossible.

FIG. 2 illustrates the formation of the packaging material, in which the OPP layers 101,102 which are separately manufactured are subsequently laminated together by layer 103 with the extrusion laminator 200 forming the final OPP lamination. Prior to lamination, layer 101 may have been printed using graphics application method such as flexographic or rotogra-vure as is well known in the art. Prior to lamination, layer 102 may have been metallized using vacuum deposited aluminum as is well known in the art. After printing, metallization and lamination, the rolls are slit to sizes appropriate for the finished bag size as is well known in the art. The bags are then sealed using bagmakers as is currently known in the art.

Consequently, a need exists for a recyclable film made from polymers that are easily recycled and in common usage so that the collection mechanism and outlets for the recycled resin are readily available.

### SUMMARY OF THE INVENTION

The present invention is directed towards polyethylene (PE) laminated film structures which may be easily recycled with existing recycle streams. In one aspect, the finished film structure of the present invention has one or more PE layers with each layer having only one or multiple coextrusions. In one aspect, the film structure of the present invention further comprises a homogeneous film of a single PE layer with an optional graphics layer. In one aspect, the film structure of the present invention further comprises one or more PE skin layers to promote ink adhesion for the addition of a graphics layer. In one aspect, the film structure of the present invention further comprises a sealant layer for forming a back seal on packaging comprising one or more embodiments of the inventive film structure disclosed herein with known ultrasonic sealing techniques.

In one aspect, the film structure of the present invention comprises a laminated multi-film structure. The lamination is accomplished by extrusion lamination with lamination of a blown film layer to a cast film layer by a PE extrusion layer results in a film with excellent stiffness and puncture resistance. In one aspect, the inventive film structure disclosed herein may further comprise optional layers, such as an ink adhesion/graphics layer, a barrier layer, or additional layers for improved lamination bonds. The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as a preferred mode of use, further objectives and advantages thereof, will be best understood by reference to the following detailed description of illustrative embodiments when read in conjunction with the accompanying drawings, wherein:

FIG. 1 depicts a cross-section of an exemplary prior art film structure;

FIG. 2 depicts the exemplary formation of a prior art film structure;

FIG. 3 depicts a magnified schematic cross-section of a mono-layer film structure according to one embodiment of the invention;

FIG. 4 depicts a magnified schematic cross-section of a multi-layer film structure according to one embodiment of the invention;

FIG. 5 depicts a magnified schematic cross-section of a multi-layer film structure according to one embodiment of the invention; and,

FIG. 6 depicts a magnified schematic cross-section of a multi-layer film structure according to one embodiment of the invention.

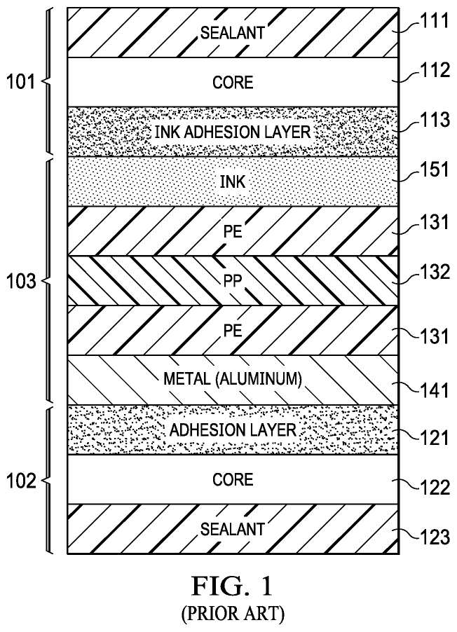

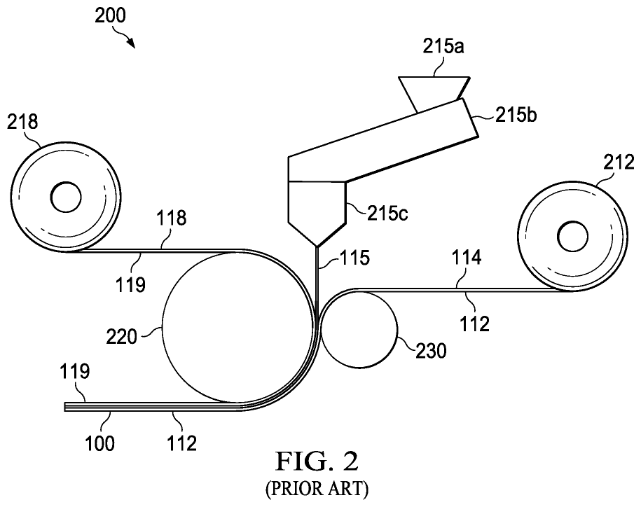

### DETAILED DESCRIPTION

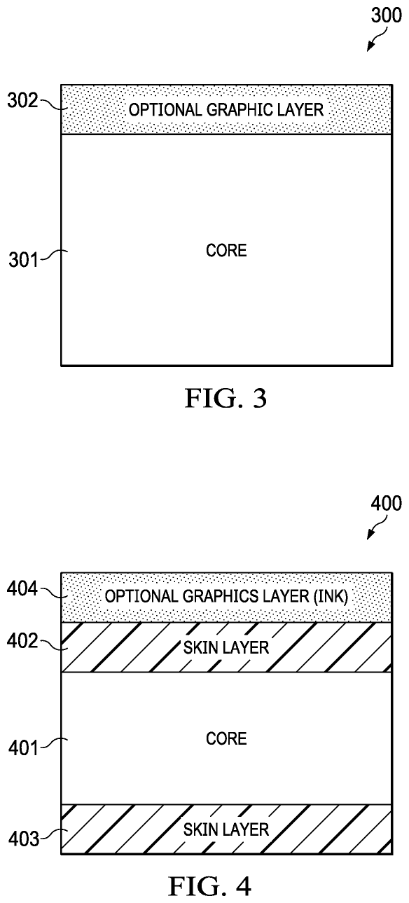

One embodiment of the present invention is directed towards use of PE mono-layer film structure in a flexible film packaging. FIG. 3 depicts a magnified schematic cross-section of a mono-layer film 300 made with PE according to one embodiment of the invention. The mono-layer film 300 depicted in FIG. 3 includes a homogeneous core layer 301 with optional graphics layer 302. This structure at the proper thickness is suitable for many bag-in-box applications such as cookies, crackers or cereals. Mono-layer film 300 may range in layer thickness from 20 microns to 300 microns depending on the end-use application for which mono-layer film 300 is being manufactured. Mono-layer film 300 may be produced by blown film assets (such as those used for making grocery sacks) or by cast film lines as known in the art. Other orientation techniques such as tenter frame, commonly used for OPP, are capable of producing film for the disclosed structures, but their configurations make them less efficient than lines designed for making polyethylene. However, the structure depicted in FIG. 3 is generally not suitable for use in typical heat seal VFFS packaging operations as it does not have a separate sealant layer.

Modern packaging sealing operations now use ultrasonic sealing techniques and the various embodiments of the invention disclosed herein work well with such equipment and sealing processes. An example of such ultrasonic technology used in sealing flexible film packages is described in U.S. Pat. No. 9,090,021 (Cham et al.). In ultrasonic sealing, the traditional heat-sealing mechanism is replaced with ultrasonic sealing components. Ultrasonics use high frequency vibrations to weld the material together. Advantages of ultrasonics include smaller seals. Seal sizes can be reduced from a typical ½ inch (12 mm) to 1 mm a greater than 90% reduction in seal area. Ultrasonic seals allow a seal to be formed in areas where leaks caused by debris such as salt or crumbs would cause an issue, as ultrasonic sealing provides a seal through the debris whereas heat sealing methods cannot. Moreover, ultrasonics do not generate heat to make the seals, thus complex sealant layers are not required in the film structure, and issues related to hot tack and recycle stream compatibility are resolved because there is not requirement to allow the sealant to cool for hot tack and the absence of a sealant improves recycling capability.

As noted, the various film structure embodiments disclosed herein provide an alternative to and enable VFFS equipment outfitted with ultrasonic sealing apparatus to make seals without the need for the film structure to include one or more sealant layers. The disclosed film structures may be produced from any polymer, but polyethylene and polyester are preferred because films made from these materials have large, viable recycling streams in place. Polyethylene is particularly preferred because it's recycle stream may have pigmented polymers already present. The film structures disclosed herein may be comprised of various polyethylene types including high-density polyethylene (HDPE), low-density polyethylene (LDPE), linear low-density polyethylene (LLDPE) or ultra low-density polyethylene (UDLPE).

FIG. 4 depicts a magnified schematic cross-section of a multi-layer film structure made according to one embodiment of the invention. In the depicted embodiment, film structure 400 comprises an inner PE core layer 401 with skin layers 402,403 adjacent to core layer 401. Skin layers 402, 403 can be used to promote ink adhesion for the addition of an optional graphics layer 404, improving COF for easier machine processing and for sealing purposes. A sealant layer (not shown) may be added to provide for the creation of a vertical back seal. An appropriate sealant may be selected and utilized that does not require hot tack and is compatible with recycling operations, such as those used on grocery sacks. The use of ultrasonic sealing for sealing packaging made from film structure 400 is still preferred because the recycle compatible sealant layers do not possess sufficient hot tack. Film structure 400 may be manufactured via blown film processes, cast film processes or tenter processes from the substrates and materials described herein. In an embodiment, film structure 400 is manufactured from homogenous polyethylene and combinations of HDPE and LLDPE.

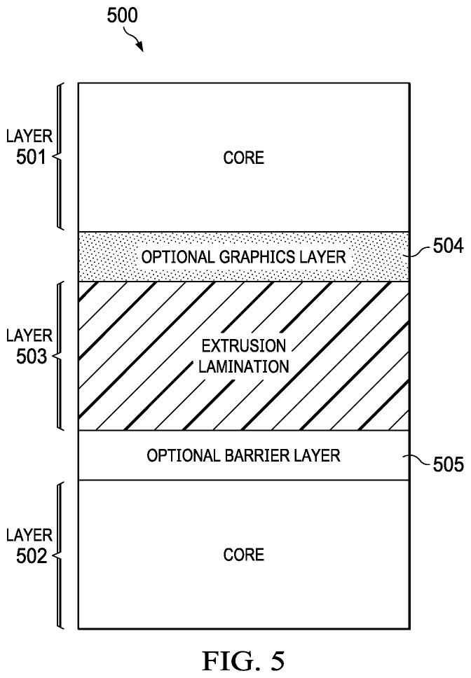

FIG. 5 depicts a magnified schematic cross-section of a laminated multi-layer film structure according to one embodiment of the invention. In the depicted embodiment, film structure 500 comprises blown film layer 501 laminated to cast film layer 502 by polyethylene extrusion layer 503 resulting in a film with excellent stiffness and puncture resistance properties. In an embodiment, the lamination of film layer 501 and film layer 502 is made by extrusion lamination which uses polyethylene or a polyethylene extrudate and is well known in the art. In an embodiment, film layer 501 and film layer 502 are laminated using an adhesive such as epoxy, urethane, or polyethylenimine (PEI). The resulting film 500 can be optionally printed or left plain for applications such as bag-in-box applications. Film 500 may further comprise optional layers, such as ink adhesion/graphics layer 504, barrier layer 505 if barrier properties are required, or additional layers for improved lamination bonds. Although film 500 comprises a multi-layer film structure, it is still fully recyclable in known recycle stream operations.

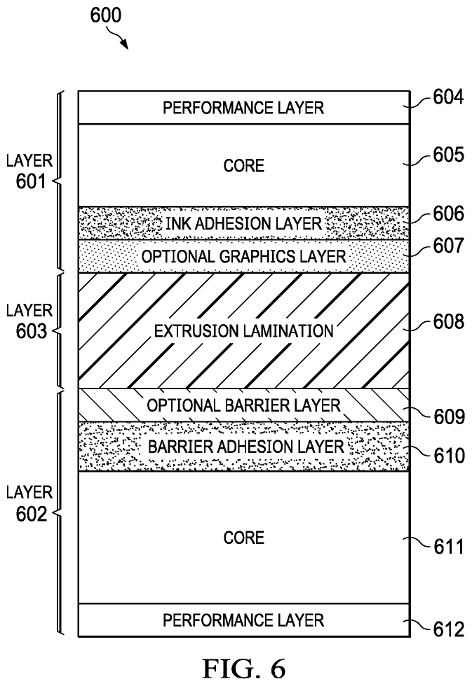

FIG. 6 depicts a magnified schematic cross-section of a laminated multi-layer film structure according to one embodiment of the invention. In the depicted embodiment, film structure 600 compromises core film layers 601,602 laminated together with extrusion lamination layer 603. Each film layer 601,602 may contain multiple coextrusions ranging from three to nine for each film. Film layers 601,602 may be either blown or cast from HDPE or other PE variants. Film structure 600 may comprise a lamination of two blown films, two cast films or one cast film and one blown film in various contemplated embodiments. Extrusion lamination layer 603 may also comprise a coextrusion in an embodiment, such as an Ethylene vinyl alcohol (evoh) layer 613 made from an evoh of low hydrolysis, such as one with 32% hydrolysis level to provide enhanced oxygen barrier while being compatible with recycling operations.

In an embodiment, film layer 601 comprises two coextrusion skins, such as ink adhesion layer 606 and graphics layer 607 on one side adjacent to film core 605, and performance sealant layer 604 on the opposite side and adjacent to film core 605 that provides controlled COF and sealant properties adequate to make a vertical back seal. Inner coextrusion graphics layer 607 may be flame treated and printed with high fidelity print graphics. In an embodiment, film layer 602 comprises a multilayer coextrusion with performance sealant layer 612 that is compatible with sealant layer 604 for making back seals. Sealant layers 604,612 may be similar or identical. Barrier adhesion layer 610 may be flame treated for excellent adhesion for metallization and barrier layer 609 may be vacuum metallized with aluminum. Bonding layer 608 is comprised of PE and maybe formed by extrusion lamination. In an embodiment, all film layers and coextrusions are preferably made from PE with HDPE being preferred for the core 605, 611 and LLDPE being preferred for the coextrusion and lamination bonding layers 608 by extruding a biodegradable bio-based film into a film sheet. Although the disclosed embodiment comprises a multi-layer film structure, the disclosed structure(s) remain compatible with existing recycling operations.

The inventive embodiments disclosed herein may utilize flame treatment to enhance the surface energy of the polyethylene films thereby improving wetting and adhesion properties of the film surface. Flame treatment limits the use of corona treatment because of corona treatment's negative effect on polyethylene. In an embodiment, the polyethylene films disclosed herein may be treated with mono atomic oxygen via flame treatment, or other mono atomic oxygen production processes as known in the art, resulting in an oxidized film surface layer or layers improving surface adhesion of the polyethylene film thereby improving the wetting and adhesion properties of the film surface. The invention disclosed herein may utilize ultrasonic sealing to provide for the manufacture of packaging that use minimal or no sealant layers. When sealant layers are used, they are not complex blends of multiple polymers or resin types, they contain fewer additives, they do not need to offer hot tack and are focused against making the vertical back seal. The resins used in making the invention disclosed herein are preferably polyethylene-based and are compatible with existing recycle streams.

The inventive embodiments disclosed herein may be formed or made using blown and cast film processes and techniques as known in the art. Such processes may be used to produce and achieve a balanced film orientation. In an embodiment, a balanced film orientation is achieved when the film is oriented about 5× in length and 5× in width. As a reference example, oriented polypropylene (OPP) film is typically oriented 5-6× in length and 7-9× in width resulting in a overall orientation between 40×-50×. In an embodiment, the film layer is produced using a cast film process resulting in a virtually unoriented film.

The invention disclosed herein provides numerous advantages over traditional prior art films. First, the present invention maybe manufactured by and utilizes existing film production assets to make the disclosed polyethylene-based film structures. The present invention may also be produced by the conversion of existing film production assets in the printing, metallization, lamination and slitting of the various disclosed film structures. The present invention also takes advantage of the large supply of petroleum-based resources that have been unlocked by hydraulic fracking and abundant natural gas that has been part of the fracking revolution.

As used herein, the term “package” should be understood to include any container including, but not limited to, any food container made up of mono-layer or multi-layer films. The sealant layers, adhesive layers, graphics layers, barrier layers and adhesive layers discussed herein are suitable for forming packages for snack foods, such as potato chips, corn chips, tortilla chips and the like. However, while the layers and films discussed herein are contemplated for use in processes for the packaging of snack foods, such as the filling and sealing of bags of snack foods, the layers and films may also be used in processes for packaging other low moisture products. While this invention has been particularly shown and described with references to various contemplated embodiments, it will be understood by those skilled in the art that various changes in form and detail may be made therein without departing from the spirit and scope of the invention.

We claim:

1. A packaging film comprising:
a first layer comprising a polyethylene-based film.

2. The film of claim 1 further comprising a graphics layer adjacent to said first polyethylene-based film layer.

3. The film of claim 1 further comprising a sealant layer adjacent to said first polyethylene-based film layer.

4. The film of claim 1 wherein said first polyethylene-based film layer thickness is in the range between 20 microns to 100 microns.

5. The film of claim 1 wherein said first polyethylene-based film layer is laminated to a second polyethylene-based film layer.

6. The film of claim 1 wherein the polyethylene-based film is one selected from the group of high-density polyethylene, low-density polyethylene, linear low-density polyethylene or ultra-low-density polyethylene.

7. The film of claim 1 wherein the polyethylene-based film is made using a blown film process achieving a balanced orientation.

8. The film of claim 5 wherein said first and second polyethylene-based film layers are laminated by extrusion lamination using a polyethylene extrudate.

9. The film of claim 5 wherein said first and second polyethylene-based film layers are laminated using an adhesive comprising an epoxy, a urethane, or polyethylenimine.

10. The film of claim 5 wherein said first polyethylene-based film layer includes a printed graphic and the second polyethylene-based film layer is transparent.

11. The film of claim 5 wherein said first polyethylene-based film layer includes a printed graphic and the second polyethylene-based film layer is metallized by vacuum deposition.

12. The film of claim 11 wherein the film has been treated by flame or corona treatment.

13. The film of claim 11 further comprising an exposed sealant layer optimized for hot tack and seal strength.

14. The film of claim 11 further comprising an exposed sealant layer is optimized for COF.

15. The film of claim 11 wherein the polyethylene-based film is one selected from the group of high-density polyethylene, low-density polyethylene, linear low-density polyethylene or ultra-low density polyethylene.

16. The film of claim 11 wherein the polyethylene-based film is made using a blown film process achieving a balanced orientation.

17. The film of claim 11 wherein the polyethylene-based film is produced using a cast film process and the film is virtually unoriented.

18. The film of claim 11 wherein the film has been treated with mono atomic oxygen.

19. The film of claim 1 wherein the polyethylene-based film is formed into a package by an ultrasonic sealing method.

20. The film of claim 11 wherein the polyethylene-based film is formed into a package by an ultrasonic sealing method.
